(19) United States
(12) Patent Application Publication
(10) Pub. No.: US 2008/0223236 A1
(43) Pub. Date: Sep. 18, 2008

(54) Sheet processing device

(75) Inventors: Motoyasu Hirata, Tokyo (JP); Mitsuhiko Sato, Yamagata (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Komori Corporation

(21) Appl. No.: 11/788,717

(22) Filed: Apr. 19, 2007

(30) Foreign Application Priority Data
May 2, 2006 (JP) 128195/2006

(51) Int. Cl. B41F 13/24

(52) U.S. Cl. 101/232

(57) ABSTRACT

A sheet processing device includes a transport cylinder, processing cylinder, and blowing device. The transport cylinder holds and conveys a sheet. The processing cylinder opposes the transport cylinder, and processes the sheet conveyed by the transport cylinder. The blowing device blows air to the sheet conveyed by the transport cylinder on an upstream side in a sheet convey direction of a contact position where the sheet conveyed by the transport cylinder comes in contact with the processing cylinder.

### BACKGROUND OF THE INVENTION

The present invention relates to a sheet processing device to subject a sheet to processes, e.g., cut-marking, scoring, punching, and embossing.

As shown in Japanese Patent Laid-Open No. 2003-237018, a conventional sheet processing device comprises a processing cylinder which has, on its outer surface, a processing plate with a punching or scoring blade, and an impression cylinder which opposes this processing cylinder to hold and convey a sheet. When the sheet conveyed by the impression cylinder passes through a contact point with respect to the processing cylinder, the punching or scoring blade performs the punching or scoring process.

In the above-described conventional sheet processing device, if the sheet is not in tight contact with the outer surface of the impression cylinder when passing through the contact point with respect to the processing cylinder, the processing accuracy of the punching cylinder decreases. To cope with this problem, a tape is adhered to a plate with no blade of the processing plate to bring the sheet into tight contact with the outer surface of the impression cylinder. However, when the sheet conveyed by the impression cylinder enters the contact point with respect to the processing cylinder in a fluttering state, the entire sheet cannot come into tight contact with the outer surface of the impression cylinder with the tape even if the tape is adhered to the processing cylinder. This decreases the processing accuracy of the processing cylinder, the registration accuracy in the vertical direction of the sheet, and the processing quality, thus posing problems.

### SUMMARY OF THE INVENTION

It is an object of the present invention to provide a sheet processing device to improve the processing accuracy of a sheet and a processing quality.

In order to achieve the above object, according to the present invention, there is provided a sheet processing device comprising a transport cylinder which holds and conveys a sheet, a processing cylinder which opposes the transport cylinder, and processes the sheet conveyed by the transport cylinder, and a blowing device which blows air to the sheet conveyed by the transport cylinder on an upstream side in a sheet convey direction of a contact position where the sheet conveyed by the transport cylinder comes in contact with the processing cylinder.

### BRIEF DESCRIPTION OF THE DRAWINGS FIG. 1 is a side view of an entire sheet-fed rotary printing press to which a sheet processing device according to the present invention is applied;

FIG. 2 is a side view of a sheet processing device according to an embodiment of the present invention;

FIG. 3 is a partially cutaway plan view of the counter cylinder shown in FIG. 2;

FIG. 4A is a view seen from the line of an arrow IV in FIG. 3;

FIG. 4B is an enlarged view of the recess portion of a gripper pad bar;

FIG. 5A is a view seen from the line of an arrow V in FIG. 3;

FIG. 5B is a sectional view of the neck of a shaft;

FIG. 5C is a sectional view of a manipulation shaft;

FIG. 6 is a view seen from the line of an arrow VI in FIG. 3;

FIG. 7 is a developed plan view showing the sheet processing device shown in FIG. 2;

FIG. 8A is a developed plan view showing the air blowing device shown in FIG. 2;

FIG. 8B is a view seen from an arrow VIII(B) in FIG. 8A;

FIG. 9A is a view to explain the bearing structure of the counter cylinder shown in FIG. 2;

FIG. 9B is a view to explain a throw-on and throw-off device which throws a processing cylinder on/off the counter cylinder;

FIG. 10 is a partially cutaway developed plan view showing the sheet processing device shown in FIG. 2;

FIG. 11 is a view seen from an arrow XI in FIG. 10;

FIG. 12 is a block diagram showing the electrical configuration of the sheet processing device shown in FIG. 2;

FIG. 13 is an enlarged view to explain the gap amount between the shearing blade of a shearing blade plate and a plate mounted on the counter cylinder; and

FIG. 14 is an enlarged side view of the main part of the sheet processing device for explaining the state wherein a blowing means blows air.

### DESCRIPTION OF THE PREFERRED EMBODIMENT

A sheet processing device according to an embodiment of the present invention will be described with reference to FIGS. 1 to 13. As shown in FIG. 1, a sheet-fed rotary printing press 1 comprises a feed unit 3 (sheet supply unit) which feeds sheets 2 one by one, a printing unit 4 which prints on the sheet 2 fed from the feed unit 3, a coating unit 5 which coats the sheet 2 printed by the printing unit 4 with varnish, a drying unit 6 which dries the sheet 2 conveyed from the coating unit 5, a sheet processing device 7 which subjects the sheet 2 conveyed from the drying unit 6 to shearing with a predetermined pattern, and a delivery unit 8 (sheet delivery unit) which delivers the sheet 2 conveyed from the sheet processing device 7.

The feed unit 3 comprises a pile board 10 (sheet pile device) on which the sheets 2 pile up in a stacked state, and a feed device 11 (sheet supply means) which separates the sheets 2 stacked on the pile board 10 one by one and feeds them onto a feeder board 12. The printing unit 4 comprises four printing units 13 to 16. Each of the printing units 13 to 16 comprises a plate cylinder 17 to which an inking device supplies ink, a blanket cylinder 18 which opposes the plate cylinder 17, and an impression cylinder 19 which opposes the blanket cylinder 18 and conveys the sheet 2 in a gripped state.

In this arrangement, the sheet 2 that the feeder board 12 feeds to a transfer cylinder 20 is gripping-changed to the impression cylinder 19 and conveyed by it. When the sheet 2 passes through the gap between the blanket cylinder 18 and impression cylinder 19, it is printed with the first color. The sheet 2 on which the first color is printed is sequentially conveyed to the printing units 14, 15, and 16 through transfer cylinders 21a to 21c so it is printed with second, third, and fourth colors.

The coating unit 5 comprises a varnish coating cylinder 22 to which a varnish supply device supplies varnish, and an impression cylinder 23 which opposes the varnish coating cylinder 22 and conveys the sheet 2. When the sheet 2 which is printed by the printing unit 4 and gripping-changed from a transfer cylinder 21d to the impression cylinder 23 passes between the impression cylinder 23 and varnish coating cylinder 22, its surface is coated with the varnish.

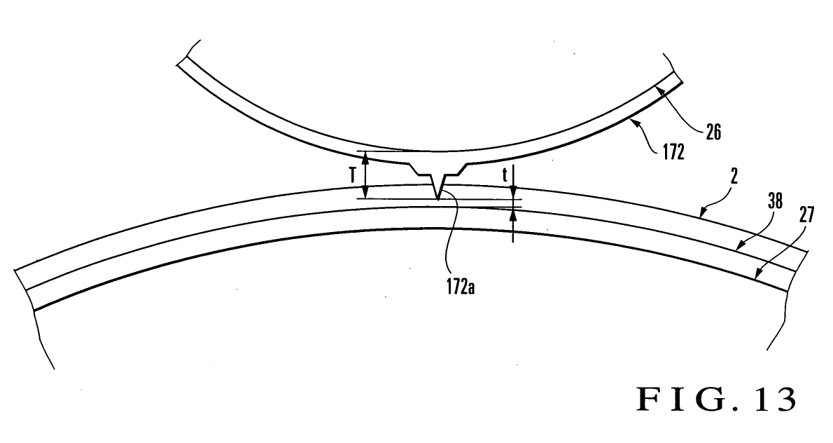

The drying unit 6 comprises UV lamps 25 which dry the ink printed by the printing unit 4 and the varnish coated by the coating unit 5, and a transfer cylinder 24 which gripping-changes and conveys the sheet 2 from a transfer cylinder 21e. The sheet processing device 7 comprises a processing cylinder 26 (machining cylinder) and a counter cylinder 27 (transport cylinder) which opposes the processing cylinder 26 and conveys the sheet 2. As shown in FIG. 13, the processing cylinder 26 has a shearing blade 172a, which shears the sheet 2 with a predetermined pattern, on its outer surface.

The delivery unit 8 comprises a sprocket 29 which is rotatably supported to be coaxial with a delivery cylinder 28 opposing the counter cylinder 27 of the sheet processing device 7, a sprocket 31 which is rotatably supported at the rear edge of a delivery frame 30, and a delivery chain 32 which loops between the sprockets 29 and 31 and supports delivery gripper bars (not shown). The delivery chain 32 and the delivery gripper bars constitute a conveying/holding device. In this arrangement, as the delivery chain 32 travels, it conveys the sheet 2 which is gripping-changed from the counter cylinder 27 to the delivery gripper bars of the delivery chain 32. The delivery gripper bars release the sheet 2 above a delivery pile 33 (delivery means) to stack the sheet 2 on the delivery pile 33.

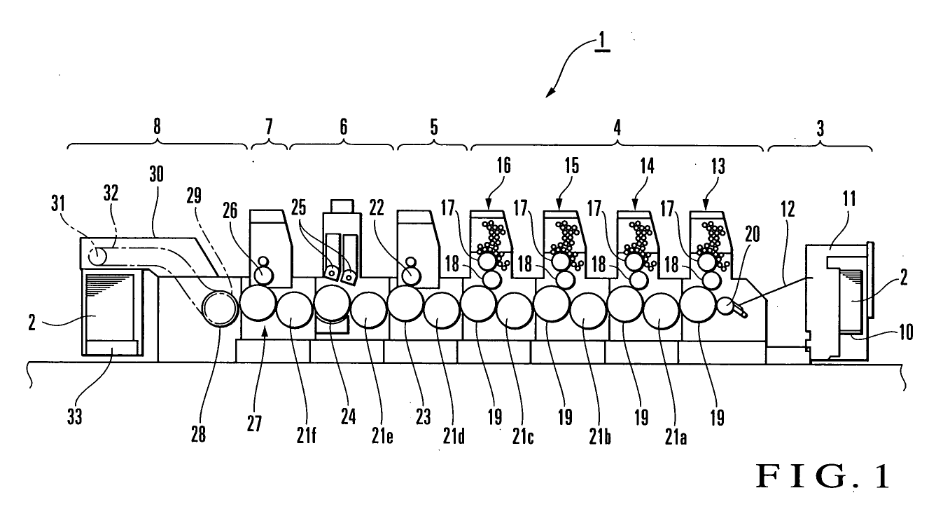

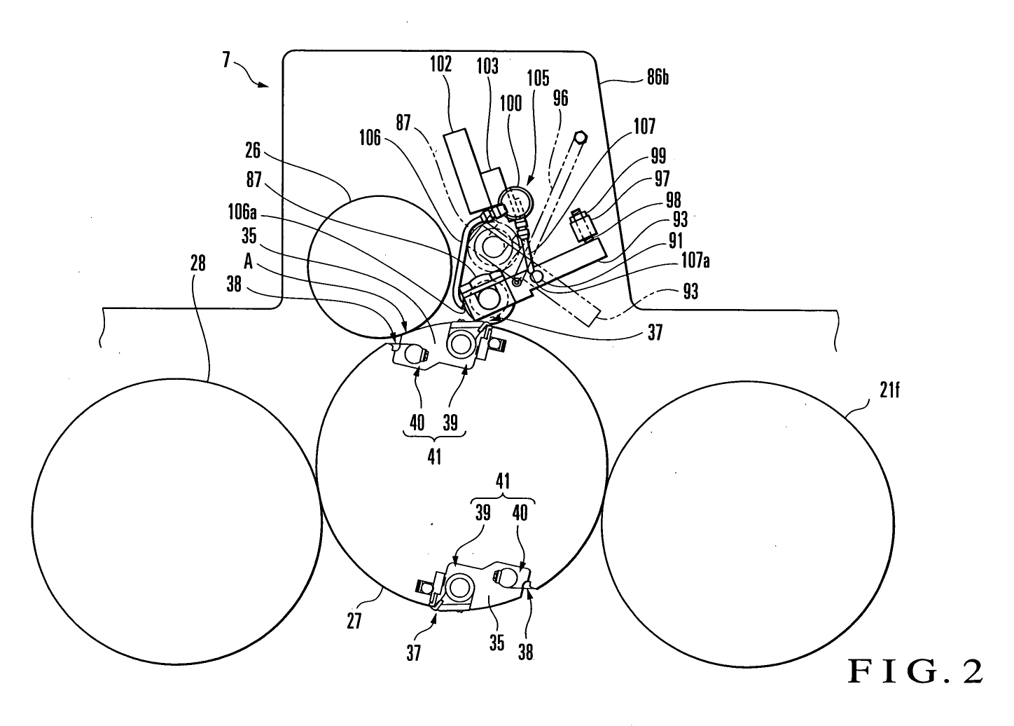

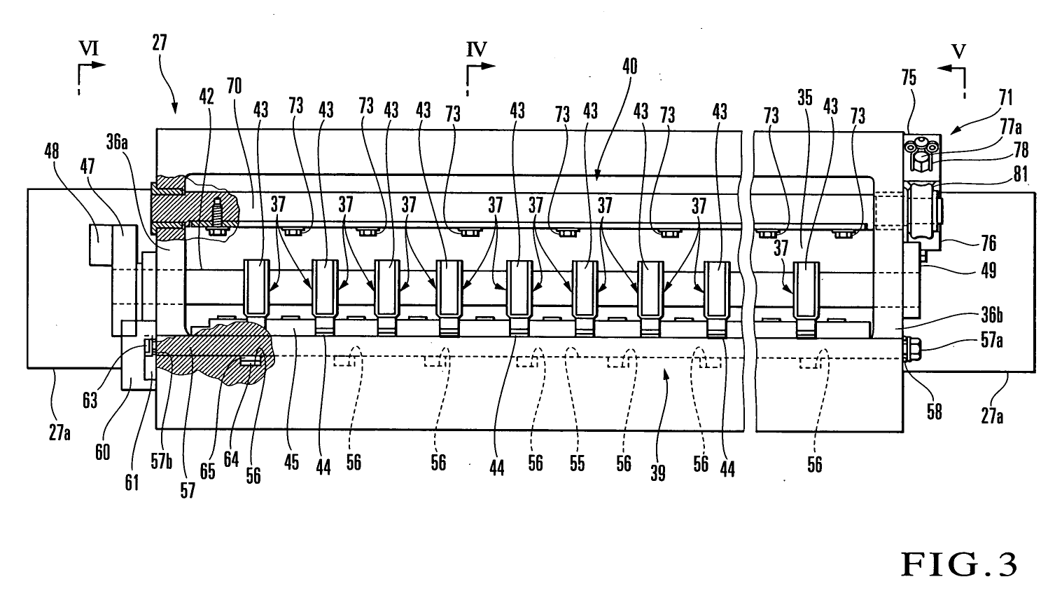

As shown in FIG. 2, the counter cylinder 27 has, in its outer peripheral portion, a pair of notches 35 which are phase-shifted from each other in the circumferential direction by 180° and extend in the axial direction. As shown in FIG. 3, bearers 36a and 36b close the two ends of each notch 35. Grippers 37 which hold the sheet 2, a leading edge plate support device 39 which supports a leading edge 38a of a plate 38 mounted on the outer surface of the counter cylinder 27, and a trailing edge plate support device 40 which supports a trailing edge 38b of the plate 38 are arranged in each notch 35. The leading edge plate support device 39 and trailing edge plate support device 40 constitute a plate support device 41.

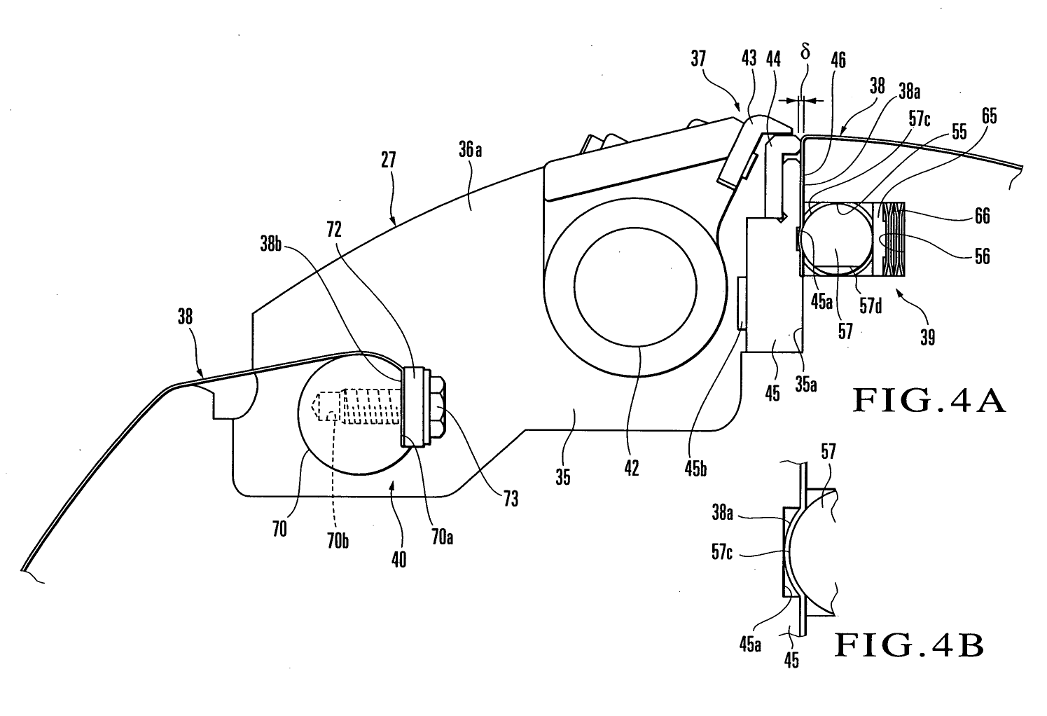

As shown in FIG. 3, the grippers 37 comprise a gripper shaft 42 rotatably, axially supported between the pair of bearers 36a and 36b, a plurality of grippers 43 supported by the gripper shaft 42 at intervals in the axial direction, and a plurality of gripper pads 44 which cooperate with the plurality of grippers 43 to grip the sheet 2. As shown in FIG. 4A, a gripper pad bar 45 with an end fixed to a wall surface 35a of the notch 35 by a bolt 45a extends in the axial direction of the counter cylinder 27. The plurality of gripper pads 44 attach to the gripper pad bar 45 at intervals.

In a space defined by the wall surface 35a of the notch 35, the end faces of the gripper pads 44, and the rear surface of the gripper pad bar 45, an insertion groove 46, to insert the leading edge 38a of the plate 38 and having a clearance δ slightly larger than the thickness of the plate 38, extends in the axial direction of the counter cylinder 27. The gripper pad bar 45 has, in its rear surface corresponding to the opening of a groove 55 (to be described later), a recess 45b which extends in the axial direction of the counter cylinder 27.

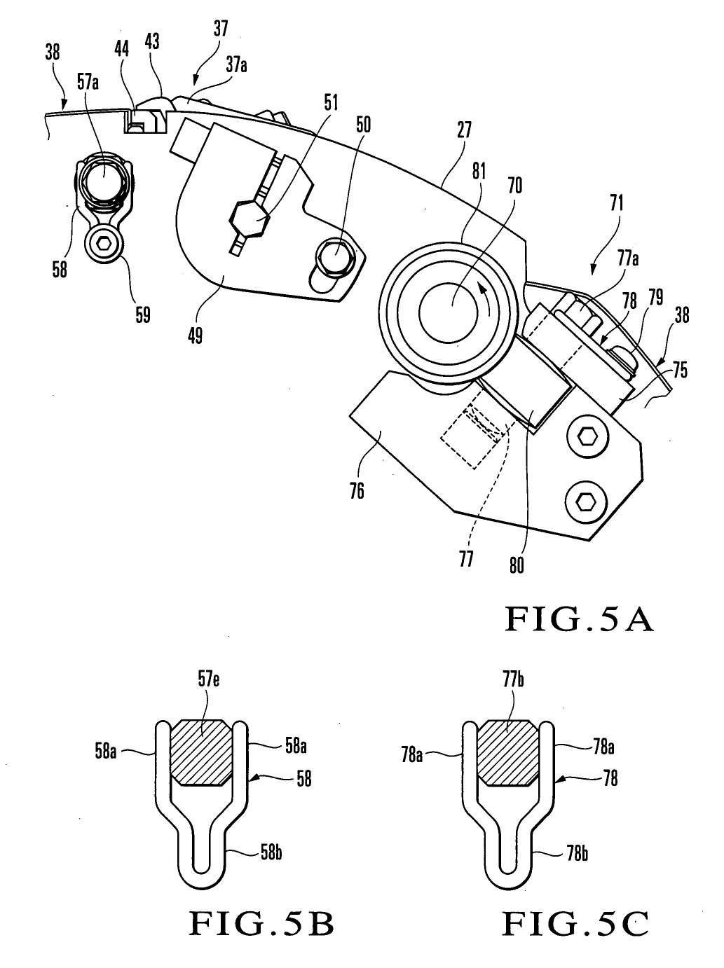

As shown in FIG. 3, one end of a lever 47 is axially mounted on that end of the gripper shaft 42 which extends from one bearer 36a. The other end of the lever 47 pivotally supports a cam follower 48. As shown in FIG. 5A, a bolt 50 attaches a torsion bar 51 of the gripper shaft 42 to the outer surface of the other bearer 36b with torsional moment being applied to it so as to open the grippers 43 with respect to the gripper pads 44.

In this arrangement, when the cam follower 48 comes into contact with the large-diameter portion of a disk cam (not shown), the shaft 42 pivots through the lever 47 against the torsional moment of the torsion bar 51, to close the grippers 43 with respect to the gripper pads 44. When the cam follower 48 passes the large-diameter portion of the disk cam, the torsional moment of the torsion bar 51 pivots the shaft 42 to open the grippers 43 with respect to the gripper pads 44. This opening/closing operation of the grippers 43 gripping-changes the sheet 2 with respect to the grippers of a transfer cylinder 21f or the delivery gripper bars of the delivery chain 32.

The leading edge plate support device 39 will be described with reference to FIGS. 3 to 6. As shown in FIGS. 3 and 4A, the wall surface 35a of the notch 35 has the groove 55 extending through the counter cylinder 27 in the axial direction. The bottom of the groove 55 has a large number of recesses 56 at intervals in the axial direction of the counter cylinder 27. A plate fixing shaft 57 rotatably supported by the groove 55 and gripper pad bar 45 fits in the groove 55, and its two ends 57a and 57b project from the bearers 36b and 36a, respectively, as shown in FIG. 3.

As shown in FIG. 4A, the shaft 57 has, in its outer surface, a press portion 57c having an arcuate section and a non-press portion 57d extending in the axial direction and having a flat section. The shaft 57 has a hexagonal manipulating portion at its one end 57a projecting from the bearer 36b, and a neck 57e with an almost square section, as shown in FIG. 5B, at the proximal end of the manipulating portion 57a.

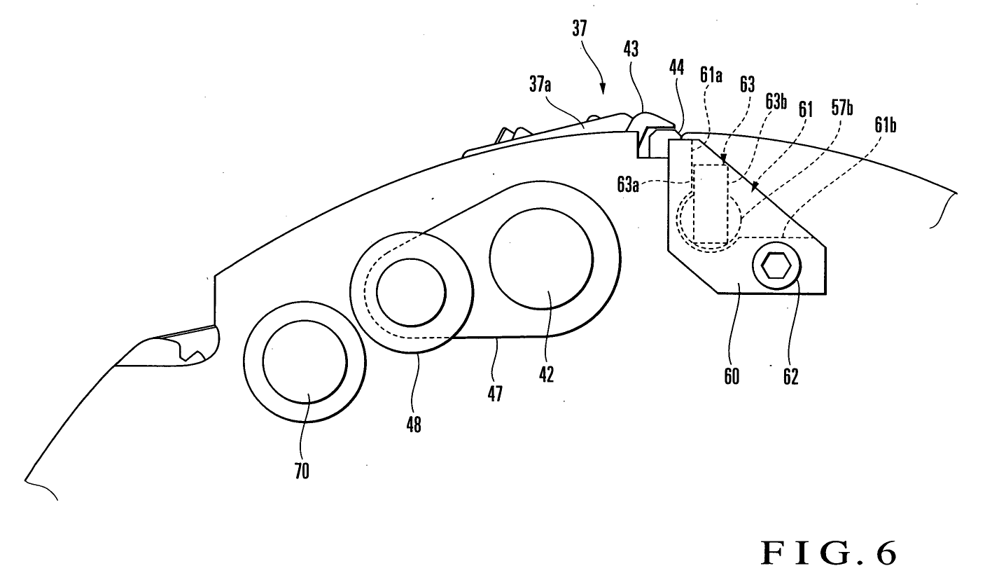

A pair of distal ends 58a of an almost U-shaped spring 58, a proximal end 58b of which is attached to the bearer 36b with a bolt 59, sandwich the two opposing sides of the neck 57e. Sandwiching of the neck 57e with the spring 58 regulates the rotation of the shaft 57. Thus, during operation of the printing press, the rotation of the shaft 57 is regulated. As shown in FIGS. 3 and 6, the other end 57b of the shaft 57 projects from the bearer 36a. A bolt 62 attaches a bracket 60 to the bearer 36a such that the projecting other end 57b corresponds to a recess 61.

The recess 61 of the bracket 60 has a pair of stopper surfaces 61a and 61b which are almost perpendicular to each other. A rectangular parallelepiped engaging body 63 having engaging surfaces 63a and 63b to engage with the stopper surfaces 61a and 61b attaches to the other end 57b of the shaft 57. In this arrangement, when the operator pivots the manipulating portion 57a of the shaft 57 with a hexagonal socket head spanner or the like against the biasing force of the spring 58, the engaging surface 63a of the engaging body 63 engages with the stopper surface 61a, as shown in FIG. 6. At this time, as shown in FIG. 4A, the press portion 57c of the shaft 57 opposes the recess 45b of the gripper pad bar 45.

When the operator further pivots the manipulating portion 57a of the shaft 57 through approximately 90°, the engaging surface 63b of the engaging body 63 engages with the stopper surface 61b, and the non-press portion 57d of the shaft 57 opposes the recess 45b of the gripper pad bar 45. At this time, a plurality of coned disk springs 66 are elastically mounted in a compressed state between a pushing piece 65 which is in contact with the outer surface of the shaft 57 and the bottom surface of each recess 56. Thus, the pushing piece 65 pushes the shaft 57.

The leading edge 38a of the plate 38, which is bent almost at a right angle is inserted in the insertion groove 46 between the gripper pad bar 45 and the wall surface 35a of the notch 35. While the press portion 57c of the shaft 57 opposes the recess 45b of the gripper pad bar 45, as shown in FIG. 4B, the spring force of the coned disk springs 66 makes it possible to sandwich the leading edge 38a of the plate 38 between the press portion 57c and the bottom surface of the recess 45b.

The trailing edge plate support device 40 will be described with reference to FIGS. 3 to 6. As shown in FIG. 3, the trailing edge plate support device 40 comprises a winding shaft 70 which is rotatably, axially supported between the pair of bearers 36a and 36b, and a manipulation device 71 which pivots the winding shaft 70 to wind a trailing edge 40b of the trailing edge plate support device 40 around the winding shaft 70.

As shown in FIG. 4A, the winding shaft 70 has, at part of its outer surface, an attaching surface 70a extending in the axial direction and having a flat section. The attaching surface 70a has a plurality of screw holes 70b to line up in the axial direction. A press bar 72, which extends in the axial direction of the winding shaft 70 to be in contact with the attaching surface 70a, has a plurality of insertion holes (not shown) to line up in the axial direction. Bolts 73 which are inserted in the plurality of insertion holes to threadably engage with the screw holes 70b attach the press bar 72 to the attaching surface 70a.

The plate 38 has, at its trailing edge 38b which is bent at an almost right angle, a plurality of U-grooves (not shown) corresponding to the screw holes 70b. Engaging the U-grooves with the bolts 73 threadably engaging with the screw holes 70b, and fastening the bolts 73 sandwich the trailing edge 38b of the plate 38 between the press bar 72 and attaching surface 70a.

As shown in FIG. 5A, the manipulation device 71 comprises a bracket 76 attached to the bearer 36b by a bolt, a bracket 75 fixing to one side surface of the bracket 76, and a manipulation shaft 77 rotatably supported by the brackets 75 and 76. The manipulation shaft 77 has, at its one end, a hexagonal manipulating portion 77a projecting from the bracket 75. The proximal end of the manipulating portion 77a has a neck 77b (FIG. 5C) with an almost square section.

A pair of distal ends 78a of an almost U-shaped spring 78, a proximal end 78b of which is attached to the bracket 75 with a bolt 79, sandwich the two opposing sides of the neck 77b. Sandwiching of the neck 77b with the spring 78 regulates the rotation of the manipulation shaft 77. Thus, during operation of the printing press, the rotation of the manipulation shaft 77 is regulated. A worm 80 axially mounted on the manipulation shaft 77 meshes with a worm wheel 81 axially mounted on one end of the winding shaft 70.

In this arrangement, when the operator pivots the manipulating portion 77a of the manipulation shaft 77 with a hexagonal socket head spanner or the like, the worm wheel 81 pivots counterclockwise in FIG. 5A through the worm 80, and the winding shaft 70 pivots clockwise in FIG. 4A. This winds the trailing edge 38b of the plate 38 around the winding shaft 70. At this time, as the plate 38 is pulled in the circumferential direction of the counter cylinder 27, it is mounted on the outer surface of the counter cylinder 27 to be in tight contact with it.

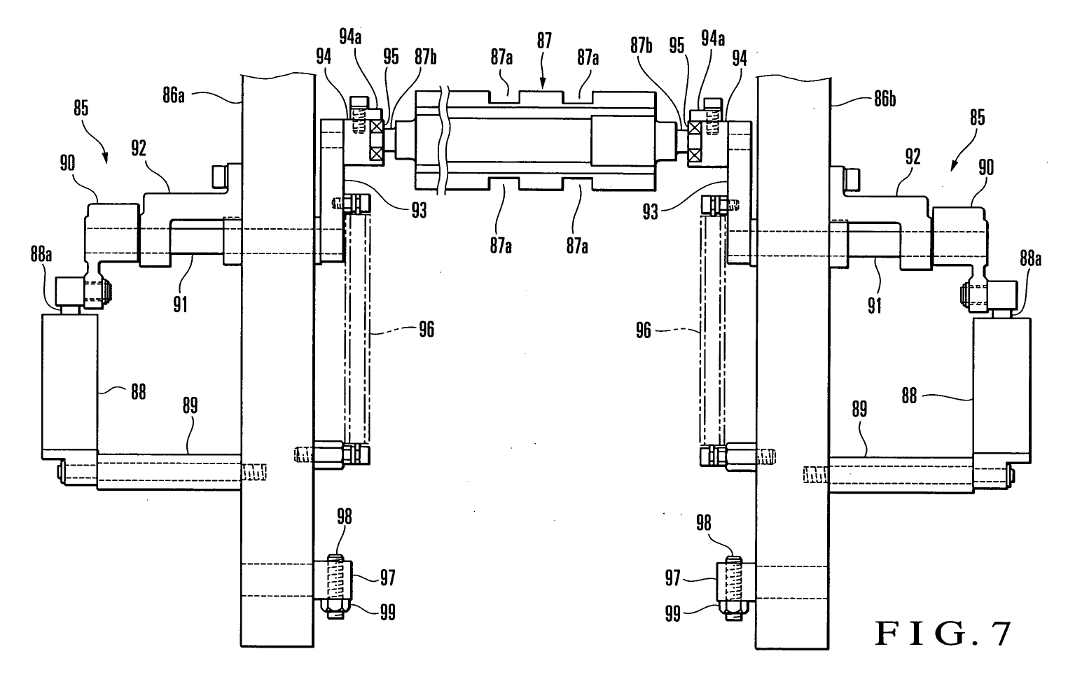

A press roller which urges the plate 38 against the outer surface of the counter cylinder 27, when mounting the plate 38 on the outer surface of the counter cylinder 27, will be described with reference to FIGS. 2 and 7. As shown in FIG. 7, a pair of frames 86a and 86b are respectively provided with a pair of moving devices 85 which move a press roller 87. The pair of moving devices 85 have the same structure. In the following description, the moving device 85 on the frame 86a side will be mainly described.

Referring to FIG. 7, one end of a lever 90 is pivotally mounted on a stretchable rod 88a of a press roller throw-on and throw-off hydropneumatic cylinder 88 (press roller throw-on and throw-off actuator) the cylinder end of which is pivotally mounted on a stud 89 which extends vertically from the frame 86a. A bracket 92 attaches to the outer side of the frame 86a. The bracket 92 and frame 86a rotatably support a corresponding one of a pair of rotating shafts 91. The other end of the lever 90 is axially mounted on one end of the rotating shaft 91 which projects outwardly through the frame 86a. As shown in FIG. 2, the central portion of a lever 93 is axially mounted on the other end of the rotating shaft 91 which projects inwardly through the frame 86a.

A bearing holder 94 having a U-shaped notch attaches to one end of the lever 93. A bearing 95 attaching to the end shaft 87b of the press roller 87 fits in the notch of the bearing holder 94. A press plate 94a fixed to the bearing holder 94 by a bolt closes the opening of the notch of the bearing holder 94. In this arrangement, the pair of bearing holders 94 rotatably support the two end shafts 87b of the press roller 87. Thus, the pair of moving devices 85 support the press roller 87 to be swingable about the rotating shafts 91 as the center.

A tensile coil spring 96 hooking between the lever 93 and frame 86a biases the lever 93 clockwise in FIG. 2 about the rotating shaft 91 as the pivot center. A block 97 with a screw hole attaches to the inner side of the frame 86a. A bolt 98, which serves as a stopper that prevents the press roller 87 from falling in any notch 35 of the counter cylinder 27, threadably engages with the screw hole of the block 97.

When the other end of the lever 93 abuts against the distal end of the bolt 98, the pivot motion (swing) of the lever 93 counterclockwise in FIG. 2 is regulated. Simultaneously, the press roller 87 is positioned at an operative position (press position) where the press roller 87 presses the plate 38 against the outer surface of the counter cylinder 27. Adjustment of the pneumatic pressure of the air cylinder 88 can adjust the press force of the press roller 87 with respect to the counter cylinder 27.

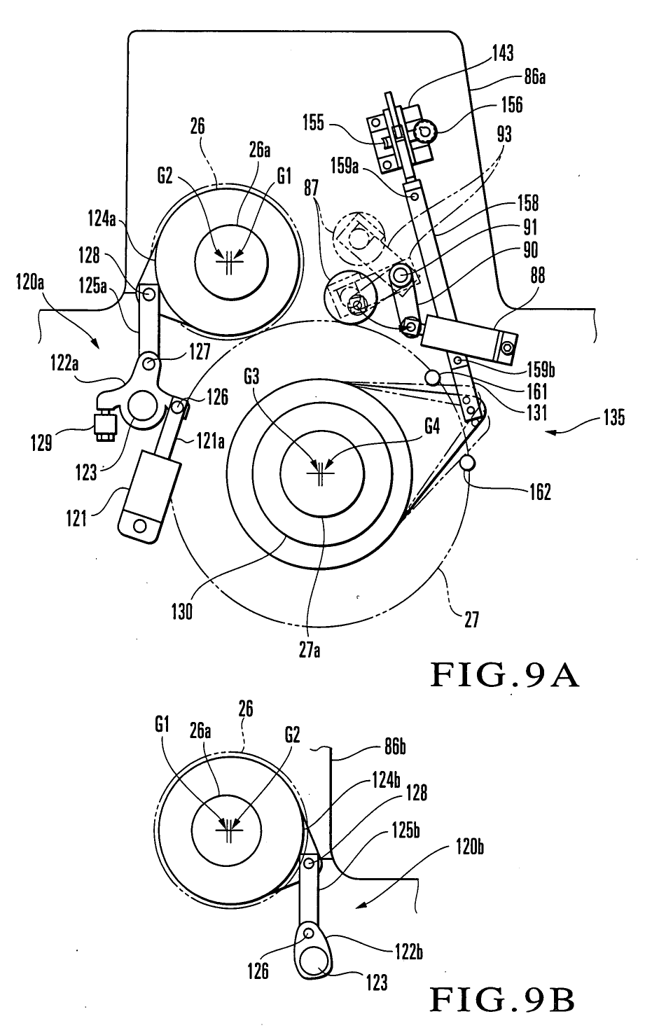

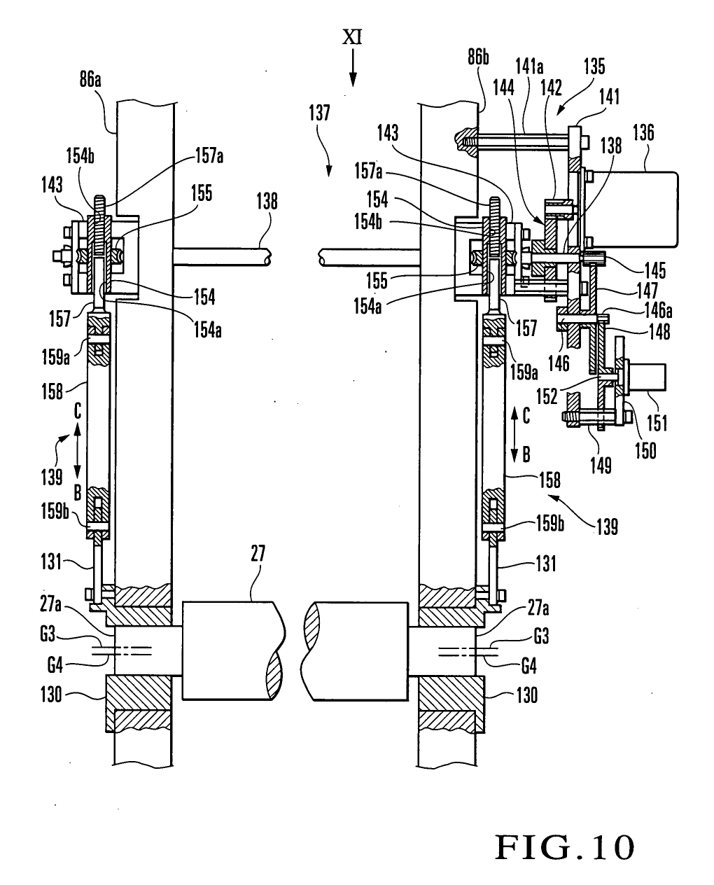

In this arrangement, when the pair of air cylinders 88 operate, the rods 88a move backward, as shown in FIG. 9A, and the rotating shafts 91 pivot counterclockwise in FIG. 2. At this time, each lever 93 also pivots counterclockwise about the corresponding rotating shaft 91 as the pivot center against the tensile force of the corresponding tensile coil spring 96, and the other end of each lever 93 abuts against the distal end of the corresponding bolt 98. Thus, the outer surface of the press roller 87 opposes the outer surface of the counter cylinder 27, and the press roller 87 is positioned at the operative position.

When the rods 88a of the pair of air cylinders 88 move forward beyond the position shown in FIG. 9A, the levers 93 pivot clockwise about the rotating shafts 91 as the pivot centers. The pivot motion of the levers 93 positions the press roller 87 at a retreat position spaced apart from the outer surface of the counter cylinder 27.

The press roller 87 has, in its outer surface, a plurality of ridges of grooves 87a to line up in the axial direction to correspond to projections 37a (FIG. 5A) of the grippers 37 projecting from the outer surface of the counter cylinder 27. The grooves 87a constitute interference avoiding portions which accommodate the projections 37a so the projections 37a do not interfere with the press roller 87.

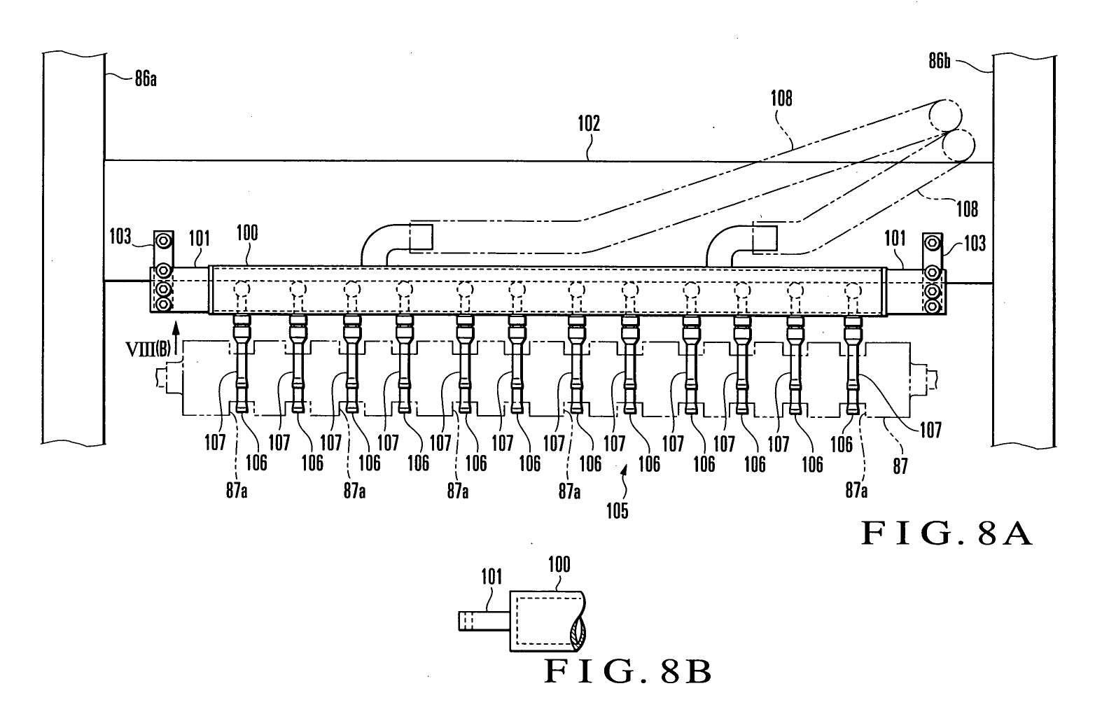

An air blowing device serving as a blowing device which blows air to the sheet 2 under conveyance by the counter cylinder 27 will be described with reference to FIGS. 2, 8A, and 14. The air blowing device can blow, to a desired narrow range, air having higher directivity in an air blowing direction than that from a blowing fan or the like. As shown in FIG. 8A, an air pipe 100 extends between the pair of frames 86a and 86b, and plate-like support pieces 101 project from the two ends of the air pipe 100. The air pipe 100 attaches to a stay 102, horizontally extending between the pair of frames 86a and 86b, through the support pieces 101 and brackets 103. The air pipe 100 has a plurality of first air blowing nozzles (to be referred to as first nozzles hereinafter) 106 and a plurality of second air blowing nozzles (to be referred to as second nozzles hereinafter) 107 which constitute an air blowing device 105.

Hoses 108 connect an air supply source (not shown) and the pipe 100. Air supplied from the air supply source to the pipe 100 through the hoses 108 blows out through air blow-off ports 106a (FIG. 2) of the first nozzles 106 and air blow-off ports 107a (FIG. 2) of the second nozzles 107. The air blow-off ports 106a and 107a of the first and second nozzles 106 and 107 are arranged on the more upstream side in the sheet convey direction of a contact position A of the sheet 2, which is under conveyance by the counter cylinder 27, with respect to the processing cylinder 26, at a position to blow air in the vicinity of the contact position A toward the sheet 2.

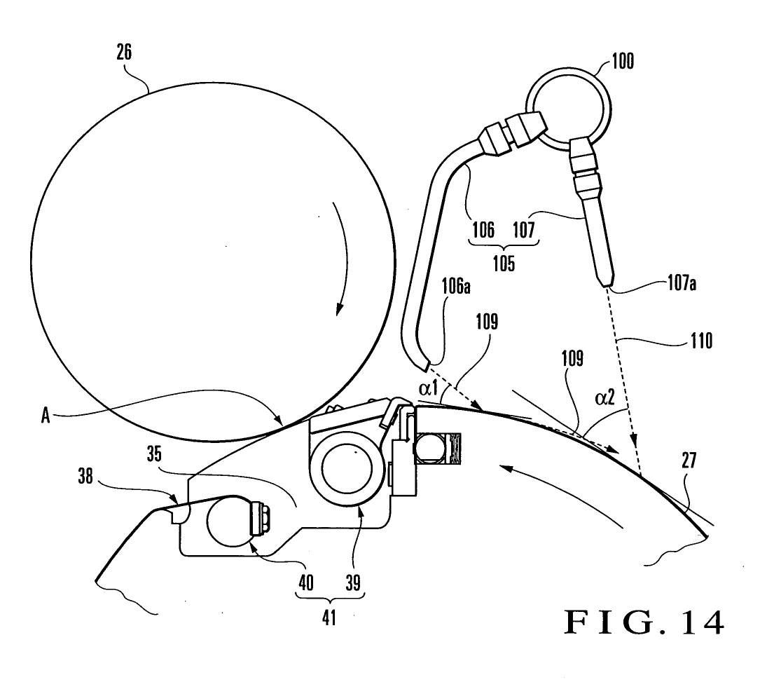

The air blow-off ports 106a of the first nozzles 106 are inclined at an angle α1 with respect to the outer surface of the counter 27. Therefore, as shown in FIG. 14, air 109 from the air blow-off ports 106a of the first nozzles 106 blows out obliquely toward the upstream side in the sheet convey direction with respect to the outer surface of the counter cylinder 27. The air 109 from the first nozzles 106 presses the sheet 2 against the plate 38 mounted on the outer surface of the counter cylinder 27, and stretches the sheet 2 toward the upstream side in the sheet convey direction, so the sheet 2 comes into tight contact with the plate 38 on the outer surface of the counter cylinder 27.

The air blow-off ports 107a of the second nozzles 107 are arranged on the more upstream side in the sheet convey direction of the air blow-off ports 106a of the first nozzles 106, and directly blows air toward the surface of the sheet. The air blow-off ports 107a of the second nozzle 107 are inclined at the angle α2 (α1<α2) larger than the angle α1 of the air blow-off ports 106 with respect to the outer surface of the counter cylinder 27. Hence, air 110 from the air blow-off ports 107a of the second nozzles 107 blows out the surface of the sheet 2 under conveyance by the counter cylinder 27. The air 110 from the second nozzles 107 suppresses flutter of the sheet 2. Due to the synergetic effect with air 110 from the second nozzles 107, the effect of air 109 from the first nozzles 106 to bring the sheet 2 into tight contact with the plate 38 improves.

Throw-on and throw-off devices 120a and 120b which throw the processing cylinder 26 on/off the counter cylinder 27, and the bearing structure of the counter cylinder 27 will be described with reference to FIG. 9A and FIGS. 9B to 11. The throw-on and throw-off device 120a is provided to the frame 86a, and the throw-on and throw-off device 120b is provided to the frame 86b. As shown in FIG. 9A, the throw-on and throw-off device 120a comprises an air cylinder 121 for throwing on/off the processing cylinder and having a rod 121a, a lever 122a connecting to the air cylinder 121, a driving shaft 123 with one end axially mounted on the lever 122a, and a rod 125a which connects the lever 122a to a throw-on and throw-off eccentric bearing 124a.

The cylinder end of the air cylinder 121 is pivotally mounted on the frame 86a. The distal end of the stretchable rod 121a is pivotally mounted on one side of the lever 122a through a pin 126. The pair of frames 86a and 86b rotatably support the driving shaft 123. The other end of the driving shaft 123 is axially mounted on a lever 122b (FIG. 9B). The lower end of the rod 125a is pivotally mounted on the upper end of the lever 122a through a pin 127, and its upper end is pivotally mounted on the throw-on and throw-off eccentric bearing 124a through a pin 128. A stopper 129 which locks the other side of the lever 122a fixes to the frame 86a. When the rod 121a of the air cylinder 121 moves forward to perform an impression throw-on in which the outer surface of the processing cylinder 26 comes close to the outer surface of the counter cylinder 27, the stopper 129 regulates the lever 122a from pivoting counterclockwise in FIG. 9A.

As shown in FIG. 9B, the throw-on and throw-off device 120b comprises the lever 122b axially mounted on the other end of the driving shaft 123, and a rod 125b with a lower end pivotally mounted on the upper end of the lever 122b through the pin 126. The upper end of the rod 125b is pivotally mounted on a throw-on and throw-off eccentric bearing 124b through the pin 128.

The pair of throw-on and throw-off eccentric bearings 124a and 124b are pivotally supported in holes formed in the pair of frames 86a and 86b, to rotatably support two end shafts 26a of the processing cylinder 26. A pivot center G2 of the throw-on and throw-off eccentric bearing 124a is eccentric from an axis G1 of the end shaft 26a by a predetermined amount.

In this arrangement, in the impression throw-off state of the processing cylinder 26, when the rod 121a of the air cylinder 121 moves forward, the lever 122a pivots counterclockwise in FIG. 9A. As the lever 122a pivots, the lever 122b also pivots clockwise in FIG. 9B through the driving shaft 123. When the levers 122a and 122b pivot, the eccentric bearing 124a pivots clockwise in FIG. 9A through the rod 125a, and the eccentric bearing 124b pivots counterclockwise in FIG. 9B through the rod 125b. Consequently, the axis G1 of the processing cylinder 26 moves about the pivot center G2 of the eccentric bearing 124a as the center, to perform an impression throw-on in which the outer surface of the processing cylinder 26 comes close to the outer surface of the counter cylinder 27.

In the impression throw-on state of the processing cylinder 26, when the rod 121a of the air cylinder 121 moves backward, the lever 122a pivots clockwise in FIG. 9A. As the lever 122a pivots, the lever 122b also pivots counterclockwise in FIG. 9B through the driving shaft 123. When the levers 122a and 122b pivot, the eccentric bearing 124a pivots counterclockwise in FIG. 9A through the rod 125a, and the eccentric bearing 124b pivots clockwise in FIG. 9B through the rod 125b. Consequently, the axis G1 of the processing cylinder 26 moves about the pivot center G2 of the eccentric bearing 124a as the center, to perform an impression throw-off in which the outer surface of the processing cylinder 26 separates from the outer surface of the counter cylinder 27.

The bearing structure of the counter cylinder 27 will be described. As shown in FIG. 10, a pair of adjusting eccentric bearings 130 to which levers 131 fix respectively are rotatably supported in holes formed in the pair of frames 86a and 86b, respectively. The pair of eccentric bearings 130 rotatably support two end shafts 27a of the counter cylinder 27. Pivot centers G4 of the pair of eccentric bearings 130 are eccentric from the axes G3 of the end shafts 27a by a predetermined amount.

An adjusting device 135, which moves the counter cylinder 27 away from and toward the processing cylinder 26 to adjust the press force and processing amount of the processing cylinder 26 for the sheet 2, is provided outside the frame 86b. The adjusting device 135 comprises an adjusting motor 136 serving as a driving source, and a driving transmission device 137 which transmits driving of the motor 136 to the pair of eccentric bearings 130. The adjusting device 135 also comprises a connecting shaft 138 which drive-connects to the motor 136, and a pair of connecting devices 139 which drive-connect the pair of eccentric bearings 130 to the connecting shaft 138.

The motor 136 fixes to a subframe 141 which attaches to the frame 86b through a stud 141a. Brackets 143 attach to the pair of frames 86a and 86b, respectively. The pair of frames 86a and 86b and the brackets 143 rotatably support the connecting shaft 138. A gear 142 axially mounted on the output shaft of the motor 136 meshes with the gear 144 axially mounted on the connecting shaft 138. A gear 145 is axially mounted on that end of the connecting shaft 138 which projects from the subframe 141. The gear 145 meshes with a gear 147 axially mounted on a shaft 146 rotatably supported by the subframe 141.

The shaft 146 has a gear portion 146a at its one end. The gear portion 146a meshes with a gear 148 axially mounted on a driven shaft 152 of a potentiometer 151. A support plate 150 which attaches to the subframe 141 through a stud 149 supports the potentiometer 151.

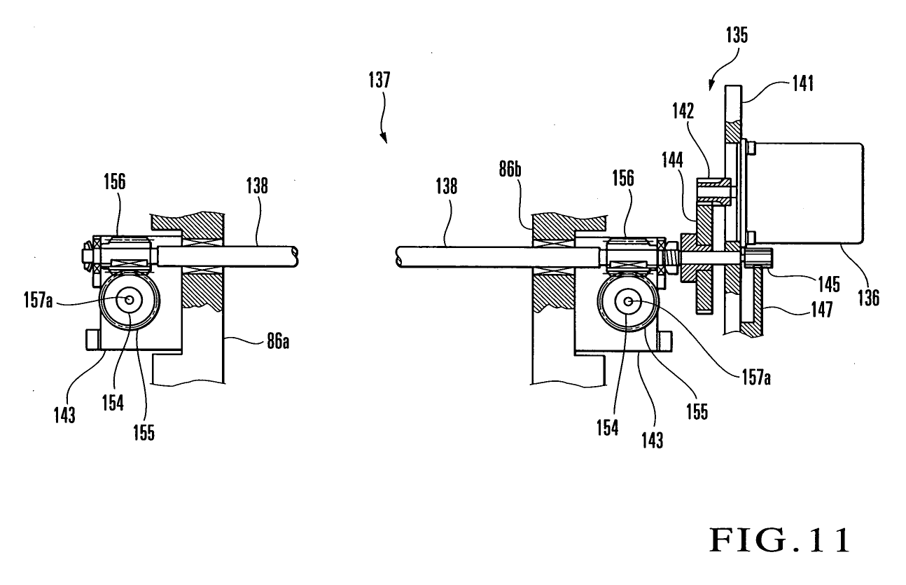

Each bracket 143 rotatably supports a rotary cylinder 154 which is rotatable and regulated from moving in the axial direction. The rotary cylinder 154 has a shaft hole 154a, and part of the shaft hole 154a forms a thread 154b. As shown in FIG. 11, a worm wheel 155, which is axially mounted on the rotary cylinder 154 and rotates together with the rotary cylinders 154, meshes with a worm 156 which is axially mounted on the connecting shaft 138 and rotates together with the connecting shaft 138.

A driving shaft 157 which connects to a rod 158 is loosely inserted in the shaft hole 154a of the rotary cylinder 154. As shown in FIG. 10, a thread 157a formed on one end of the driving shaft 157 threadably engages with the thread 154b of the rotary cylinder 154. One end of the rod 158 is pivotally mounted on the other end of the driving shaft 157 through a pin 159a. The other end of the rod 158 is pivotally mounted on one end of the lever 131 through a pin 159b.

The connecting device 139 comprises the worm 156, worm wheel 155, rotary cylinder 154, driving shaft 157, rod 158, and lever 131. As shown in FIG. 11, a worm 156 is also axially mounted on that end of the connecting shaft 138 which projects from the frame 86a. The frame 86a is also provided with the connecting device 139 comprising the worm 156, a worm wheel 155, a rotary cylinder 154, a driving shaft 157, a rod 158, and the lever 131.

As shown in FIG. 9A, stopper surfaces 161 and 162 extend vertically from the frame 86a. When driving the motor 136 to move the eccentric bearings 130 through the driving transmission device 137, the stopper surfaces 161 and 162 engage with the lever 131 to determine its moving end limit. Stopper surfaces 161 and 162 also extend vertically from the frame 86b and engage with the corresponding lever 131 in the same manner to determine its moving end limit.

In this arrangement, when driving the motor 136 in the forward direction to rotate the connecting shaft 138 through the gears 142 and 144, the rotary cylinder 154 rotates clockwise in FIG. 11 through the worm 156 and worm wheel 155 which constitute the connecting device 139 on the frame 86b side. This moves the driving shaft 157, the thread 157a of which meshes with the screw hole 154b of the rotary cylinder 154, in the direction of an arrow C in FIG. 10. Thus, the rod 158 also moves in the direction of the arrow C.

In the connecting device 139 on the frame 86a side as well, as the connecting shaft 138 rotates, the worm 156 rotates, and the rotary cylinder 154 rotates clockwise in FIG. 11 through the worm wheel 155 which meshes with the worm 156. This moves the rod 158 on the frame 86a side in the direction of the arrow C through the driving shaft 157 by the same distance as that of the rod 158 on the frame 86b side.

When the pair of rods 158 move in the directions of the arrows C, the pair of levers 131 (only one lever is shown) swing counterclockwise in FIG. 9A, and an axis G3 of the counter cylinder 27 moves about the pivot centers G4 of the pair of eccentric bearings 130 as the pivot center. Consequently, the counter cylinder 27 separates from the processing cylinder 26.

When the motor 136 is driven in the reverse direction to rotate the connecting shaft 138 in the reverse direction through the gears 142 and 144, the rotary cylinder 154 rotates counterclockwise in FIG. 11 through the worm 156 and worm wheel 155 which constitute the connecting device 139 on the frame 86b side. This moves the driving shaft 157, the thread 157a of which meshes with the screw hole 154b of the rotary cylinder 154, in the direction of an arrow B in FIG. 10. Thus, the rod 158 also moves in the direction of the arrow B.

In the connecting device 139 on the frame 86a side as well, as the connecting shaft 138 rotates, the worm 156 rotates, and the rotary cylinder 154 rotates counterclockwise in FIG. 11 through the worm wheel 155 which meshes with the worm 156. This moves the rod 158 on the frame 86a side in the direction of the arrow B through the driving shaft 157 by the same distance as that of the rod 158 on the frame 86b side.

When the pair of rods 158 move in the directions of the arrows C, the pair of levers 131 (only one lever is shown) swing clockwise in FIG. 9A, and the axis G3 of the counter cylinder 27 moves about the pivot centers G4 of the pair of eccentric bearings 130 as the pivot center. Consequently, the counter cylinder 27 moves close to the processing cylinder 26.

The rotation of the motor 136 is transmitted to the driven shaft 152 of the potentiometer 151 through the gear 142, gear 144, connecting shaft 138, gear 145, gear 147, and gear 148. The potentiometer 151 measures the amount of rotation (rotational speed) of the motor 136 on the basis of the amount of rotation (rotational speed) of the driven shaft 152.

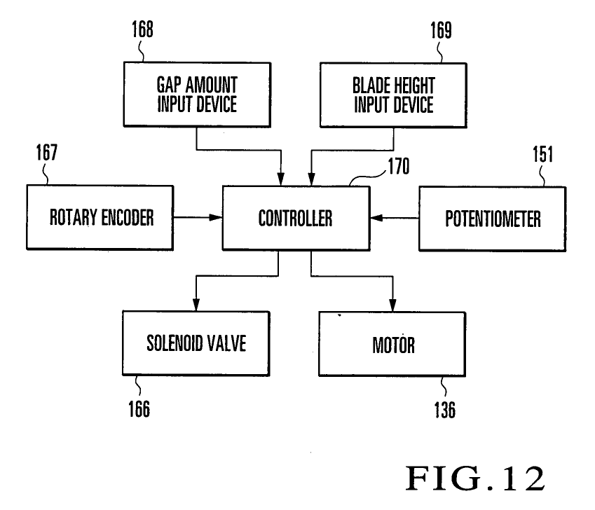

As shown in FIG. 12, the sheet processing device according to this embodiment electrically comprises, in addition to the motor 136 described above, the potentiometer 151 which detects the position of the counter cylinder 27, a solenoid valve 166 which throws on/off the processing cylinder 26, a rotary encoder 167 which detects the phase of the printing press, a gap amount input device 168, a blade height input device 169, and a controller 170. The gap amount input device 168 and blade height input device 169 comprise a touch panel which also serves as a mode selection switch and numerical value inputting keyboard on the operation panel. Selection of the input mode (gap amount input mode/blade height input mode) with the mode selection switch enables use of the common touch panel. The controller 170 controls the motor 136 and solenoid valve 166 on the basis of respective outputs from the potentiometer 151, rotary encoder 167, gap amount input device 168, and blade height input device 169.

The controller 170 opens the solenoid valve 166 to perform an impression throw-off in which the rod 121a of the air cylinder 121 moves backward to separate the outer surface of the counter cylinder 27 from the outer surface of the processing cylinder 26 (to form a gap between them). The controller 170 controls the opening/closing operation of the solenoid valve 166 on the basis of the phase of the printing press which is detected by the rotary encoder 167.

A gap amount t between the distal end of the shearing blade 172a formed on the surface of a shearing blade plate 172 mounted on the outer surface of the processing cylinder 26, and the surface of the plate 38 mounted on the counter cylinder 27, as shown in FIG. 13, is input to the gap amount input device 168 (adjusting amount input means). The gap amount t represents an amount obtained by subtracting the thickness of the sheet 2 from the forcing amount of the shearing blade 172a with respect to the sheet 2, that is, the thickness of the sheet 2 that remains without being sheared by the shearing blade 172a.

When a positive gap amount is input to the gap amount input device 168, the input numerical value represents the thickness not sheared by the shearing blade 172a. When a negative gap amount is input to the gap amount input device 168, the shearing blade 172a has pierced through the sheet 2 to bite into the plate 38 mounted on the counter cylinder 27. As the gap amount input device 168 adjusts the forcing amount of the shearing blade 172a by inputting the thickness (positive gap amount) that cannot be pierced by the shearing blade 172a, it can be referred to as a forcing amount input device as well.

A height T of the shearing blade 172a of the shearing blade plate 172 mounted on the processing cylinder 26 is input to the blade height input device 169 (reference value input means). The height T of the shearing blade 172a corresponds to the distance from the lower surface of the shearing blade plate 172 to the distal end of the shearing blade 172a, that is, the distance from the outer surface of the processing cylinder 26 mounted with the shearing blade plate 172 to the distal end of the shearing blade 172a. The controller 170 controls the motor 136 on the basis of the adjustment amount input to the gap amount input device 168, the reference value input to the blade height input device 169, and the detection result of the potentiometer 151.

The operation of the sheet processing device having the above arrangement, of mounting the plate 38 on the outer surface of the counter cylinder 27 will be described. By setting the pair of air cylinders 88 in an inoperative state in advance, the press roller 87 is positioned at a retreat position spaced apart from the outer surface of the counter cylinder 27. Then, by pivoting the manipulating portion 57a of the shaft 57, the engaging surface 63a of the engaging body 63 (FIG. 6) engages with the stopper surface 61b of the bracket 60, and the non-press portion 57d (FIG. 4A) of the shaft 57 opposes the recess 45b of the gripper pad bar 45. In this state, the leading edge 38a of the plate 38 is inserted in the insertion groove 46 between the gripper pad bar 45 and the wall surface 35a of the notches 35, as shown in FIG. 4A.

Subsequently, by pivoting the manipulating portion 57a of the shaft 57 with a hexagonal socket head spanner or the like, the engaging surface 63a of the engaging body 63 engages with the stopper surface 61a of the bracket 60, as shown in FIG. 6. At this time, as shown in FIG. 4A, the press portion 57c of the shaft 57 opposes the recess 45b of the gripper pad bar 45. Hence, the spring force of the coned disk springs 66 makes it possible to sandwich the leading edge 38a of the plate 38 between the bottom surface of the recess 45b and press portion 57c.

In this manner, by providing the stopper surface 61a (FIG. 6) that engages with the engaging surface 63a of the engaging body 63, the pivot motion of the shaft 57 stops at the position where the leading edge 38a of the plate 38 is sandwiched between the recess 45b and press portion 57c. This allows the recess 45b and press portion 57c to reliably support the leading edge 38a of the plate 38, and improves the operability. As the distal ends 58a of the spring 58 sandwich the two opposing sides of the neck 57e of the shaft 57, the shaft 57 can maintain its stopped state at a predetermined pivot position. Thus, the recess 45b and press portion 57c can reliably support the leading edge 38a.

Subsequently, the pair of air cylinders 88 actuate to move the rods 88a backward to position the outer surface of the press roller 87 at the operative position where it opposes the outer surface of the counter cylinder 27. In this state, the counter cylinder 27 pivots counterclockwise in FIG. 2 to wind the plate 38 around the outer surface of the counter cylinder 27 from the leading edge 38a side. At this time, as the press roller 87 is located at the operative position, the plate 38 is mounted as the press roller 87 urges it against the outer surface of the counter cylinder 27. Hence, the entire plate 38 is mounted in tight contact with the outer surface of the counter cylinder 27 without levitating from it.

When the trailing edge 38b of the plate 38 is positioned at the trailing edge plate support device 40, the counter cylinder 27 stops pivoting. In this state, as shown in FIG. 4A, the trailing edge 38b is inserted between the attaching surface 70a of the winding shaft 70 and the press bar 72. After the insertion, the bolts 73 are fastened to sandwich the trailing edge 38b between the press bar 72 and attaching surface 70a.

Then, by rotating the manipulating portion 77a of the manipulation shaft 77 by a hexagonal socket head spanner or the like, the worm wheel 81 rotates counterclockwise in FIG. 5A through the worm 80. This pivots the winding shaft 70 clockwise in FIG. 4A to wind the trailing edge 38b of the plate 38 around the winding shaft 70. This pulls the plate 38 in the circumferential direction of the counter cylinder 27 to be mounted on the outer surface of the counter cylinder 27.

Prior to the winding operation of the winding shaft 70, the press roller 87 has already brought the entire plate 38 into tight contact with the outer surface of the counter cylinder 27. Therefore, the pulling operation of the winding shaft 70 mounts the entire plate 38 in completely tight contact with the outer surface of the counter cylinder 27 without levitating from it.

In particular, as the angle of the bend of the leading edge 38a coincides with the angle formed by the wall surface 35a and the effective surface of the counter cylinder 27, the bend and its vicinity come into tight contact with the effective surface of the counter cylinder 27. Thus, unlike in the conventional case, the leading edge 38a does not levitate from the outer surface of the counter cylinder 27 partially from the central portion of the plate 38. This can consequently improve the registration accuracy in the vertical direction of the plate 38. As the processing cylinder 26 which opposes the counter cylinder 27 performs a uniform process, the processing quality can be improved.

The operation of processing the sheet 2 conveyed by the counter cylinder 27 with the processing cylinder 26, with the plate 38 being mounted on the counter cylinder 27, will now be described. First, the air supply source (not shown) supplies air to the air pipe 100 to blow out air from the air blow-off ports 106a of the first nozzles 106 and the air blow-off ports 107a of the second nozzles 107.

In this state, before the sheet 2, which is gripping-changed from the grippers of the transfer cylinder 21f to the grippers 37 of the counter cylinder 27 and then conveyed by the counter cylinder 27, passes through the contact position A with respect to the processing cylinder 26, the first and second nozzles 106 and 107 blow air to the sheet 2 through the air blow-off ports 106a and 107a.

Even if the sheet 2 under conveyance by the counter cylinder 27 flutters, air from the first and second nozzles 106 and 107 corrects the flutter of the sheet 2 before the sheet 2 passes through the contact position A to come into contact with the processing cylinder 26. This prevents decrease in processing accuracy of the processing cylinder 26 and decrease in registration accuracy in the vertical direction of the sheet 2 to improve the processing quality.

The air blow-off ports 107a of the second nozzles 107 are arranged on the more upstream side in the sheet convey direction of the air blow-off ports 106a of the first nozzles 106 and directed to the surface of the sheet 2 under conveyance by the counter cylinder 27. Even if a motion more violent than a flutter occurs in the sheet 2 under conveyance by the counter cylinder 27, air blown from the second nozzles 107 toward the surface of the sheet 2 suppresses the violent motion of the sheet 2. Due to the synergetic effect with air from the second nozzles 107, the effect of air from the first nozzles 106 to bring the sheet 2 into tight contact with the plate 38 improves.

More specifically, first, air from the second nozzles 107 corrects a comparatively large motion. Subsequently, the first nozzles 106 having air blowout ports directed to the upstream side in the sheet convey direction further correct the large motion of the sheet 2 that has been corrected by air from the second nozzles 107. Hence, the processing cylinder 26 processes the sheet 2 which is in reliable contact with the outer surface of the counter cylinder 27, to further improve the processing quality.

The movement of the counter cylinder 27 toward the reference position with respect to the processing cylinder 26 and the operation of changing the shearing amount of the shearing blade 172a of the shearing blade plate 172 mounted on the processing cylinder 26 will be described. First, the height T of the shearing blade 172a of the shearing blade plate 172 mounted on the processing cylinder 26 is input to the blade height input device 169. On the basis of the input height T of the shearing blade 172a, the controller 170 calculates a reference value indicating the reference position of the counter cylinder 27 when the distal end of the shearing blade 172a of the shearing blade plate 172 is to come into contact with the delivery cylinder 28 mounted on the outer surface of the counter cylinder 27.

The controller 170 calculates a target value by adding or subtracting the adjusting amount input to the gap amount input device 168 to or from the calculated reference value. The controller 170 then compares the calculated target value with the detection value of the potentiometer 151. If the two values do not coincide, the controller 170 rotatably drives the motor 136 in the forward or reverse direction until the detection value of the potentiometer 151 coincides with the target value, to position the counter cylinder 27 at a preset position.

More specifically, if the current position of the counter cylinder 27 is closer to the processing cylinder 26 than the preset position, the motor 136 is rotatably driven in the forward direction. This rotates the connecting shaft 138 to move the pair of rods 158 in the directions of the arrows C in FIG. 10. Thus, the pair of eccentric bearings 130 pivot counterclockwise in FIG. 9A.

The axis G3 of the counter cylinder 27 thus moves about the axes G4 of the pair of eccentric bearings 130 as the pivot center, so the counter cylinder 27 moves away from the processing cylinder 26. When the position of the counter cylinder 27 detected by the potentiometer 151 coincides with the calculated target value, the controller 170 stops driving the motor 136.

If the current position of the counter cylinder 27 is more separate and away from the processing cylinder 26 than the preset position, the motor 136 is rotatably driven in the reverse direction. This rotates the connecting shaft 138 to move the pair of rods 158 in the directions of the arrows B in FIG. 10. Thus, the pair of eccentric bearings 130 pivot clockwise in FIG. 9A.

The axis G3 of the counter cylinder 27 thus moves about the axes G4 of the pair of eccentric bearings 130 as the pivot center, so the counter cylinder 27 moves toward to the processing cylinder 26. When the position of the counter cylinder 27 detected by the potentiometer 151 coincides with the calculated target value, the controller 170 stops driving the motor 136.

After the counter cylinder 27 is positioned at the preset position, the sheet processing device 7 processes the sheet 2 by, e.g., punching by the shearing blade plate 172 of the processing cylinder 26. The operator inspects the sheet 2 processed by the sheet processing device 7. If the forcing amount of the shearing blade 172a needs an update, the operator inputs a gap amount to the gap amount input device 168. If the shearing amount for the sheet 2 in the shearing process is insufficient, the operator inputs a negative gap amount to the gap amount input device 168 to further increase the forcing amount.

In a process of shearing a seal member and an adhesive layer adhering to a release agent without shearing the release agent, as in processing an adhesive seal, the shearing amount may be insufficient. In this case, in order to further increase the forcing amount, the operator inputs an update gap amount, which is a positive value but smaller than the currently input gap amount, to the gap amount input device 168. The controller 170 calculates an update target value on the basis of the input update gap amount and the reference value input to the blade height input device 169, and rotatably drives the motor 136 in the reverse direction.

When the motor 136 rotates in the reverse direction, the pair of eccentric bearings 130 rotate clockwise in FIG. 9A through the connecting shaft 138, the pair of rods 158, and the like. Thus, the axis G3 of the counter cylinder 27 moves about the axes G4 of the pair of eccentric bearings 130 as the pivot center, and the counter cylinder 27 moves toward the processing cylinder 26. When the position of the counter cylinder 27 detected by the potentiometer 151 coincides with the calculated target value, the controller 170 stops driving the motor 136.

If the forcing amount of the shearing blade 172a is excessively large, in order to decrease the forcing amount, the operator inputs an update gap amount larger than the gap amount input to the gap amount input device 168. The controller 170 calculates an update target value on the basis of the input update gap amount and the reference value input to the blade height input device 169, and drives the motor 136 in the forward direction.

When the motor 136 rotates in the forward direction, the pair of eccentric bearings 130 pivot counterclockwise in FIG. 9A through the connecting shaft 138, the pair of rods 158, and the like. Thus, the axis G3 of the counter cylinder 27 moves about the axes G4 of the pair of eccentric bearings 130 as the pivot center, and the counter cylinder 27 moves away from the processing cylinder 26. When the position of the counter cylinder 27 detected by the potentiometer 151 coincides with the calculated target value, the controller 170 stops driving the motor 136.

According to this embodiment, the throwing of the processing cylinder 26 on/off the counter cylinder 27 is performed on the processing cylinder 26 side, and the adjustment of the press force of the processing cylinder 26 with respect to the sheet 2 is performed on the counter cylinder 27 side. Thus, the processing cylinder 26 and counter cylinder 27 share the clearance to be set between the frames and bearings, and between the bearings and end shafts.

When the sheet 2 passes between the counter cylinder 27 and processing cylinder 26, the processing cylinder 26 moves upward within the range of the clearance provided between the frames and bearings, and between the bearings and end shafts. The reason for this is as follows. The clearance on the processing cylinder 26 side is present in the upper portion due to the weight of the processing cylinder 26. This makes room for upward free play of the processing cylinder 26. Note that the clearance on the side of the counter cylinder 27 which is disposed under the processing cylinder 26 is present in the upper portion due to the weight of the counter cylinder 27. Even when the sheet 2 passes between the counter cylinder 27 and processing cylinder 26, the counter cylinder 27 is urged downward to where no clearance is present. Thus, the counter cylinder 27 is not subjected to free play when the sheet 2 passes.

Thus, the clearance on the processing cylinder 26 side can be decreased to be smaller than the clearance which is set between the frame and one eccentric bearing, between one eccentric bearing and the other, and between the other eccentric bearing and the end shaft in a so-called double eccentric support structure in which the throwing on/off eccentric bearing and the forcing amount adjusting eccentric bearing support the processing cylinder 26 as in the conventional case. This can minimize the free play amount of the processing cylinder 26 which is produced when processing the sheet 2, and prevent a processing error of the processing cylinder 26 for the sheet 2, thus improving the processing accuracy.

According to this embodiment, the connecting shaft 138 move the pair of eccentric bearings 130 simultaneously by the same amount, and one motor 136 causes the adjusting device 135 to perform adjusting operation. Therefore, operation amounts of the pair of eccentric bearings 130 need not be adjusted separately, so the adjusting operation can be performed accurately and easily. By only inputting numerical values to the gap amount input device 168 or/and blade height input device 169, the controller 170 can automatically, accurately adjust the shearing amount of the processing cylinder 26 with respect to the sheet 2.

When throwing the processing cylinder 26 off the counter cylinder 27, the controller 170 opens the solenoid valve 166 on the basis of the phase of the printing press detected by the rotary encoder 167 to move the rods 121a of the pair of air cylinders 121 backward. Hence, the pair of eccentric bearings 124 pivot counterclockwise in FIG. 9B through the levers 122 to move the axis G1 of the processing cylinder 26 about the axes G2 of the pair of eccentric bearings 124 as the pivot center. This consequently performs an impression throw-off in which a gap is formed between the outer surface of the counter cylinder 27 and the outer surface of the processing cylinder 26.

According to this embodiment, a plate having a shearing blade is exemplified as the plate 172 to be mounted on the outer surface of the processing cylinder 26. However, the plate can serve as a machining plate which has a shearing blade, scoring blade, or embosses to subject a sheet to punching, scoring, or embossing. A case has been described which employs the sheet 2 as the material to be processed by the plate 172 mounted on the outer surface of the processing cylinder 26. However, the material to be processed may be a film-type sheet or a thin aluminum plate.

According to this embodiment, the processing cylinder 26 is arranged above the counter cylinder 27. Alternatively, the processing cylinder 26 may be arranged under the counter cylinder 27. In this case, the air blowing nozzle is used as the blowing device. Alternatively, the blowing fan may be used.

As has been described above, according to the present invention, even if the sheet under conveyance by the transport cylinder flutters, air from the air blow-off ports of the air blowing device eliminates the flutter of the sheet before the sheet passes through the opposing position of the transport cylinder and the processing cylinder. Accordingly, the sheet comes into tight contact with the outer surface of the transport cylinder when passing through the contact point with respect to the processing cylinder. This obviates a decrease in processing accuracy of the processing cylinder and a decrease in registration accuracy in the vertical direction of the sheet to improve the processing quality.

What is claimed is:

1. A sheet processing device comprising:
a transport cylinder which holds and conveys a sheet;
a processing cylinder which opposes said transport cylinder, and processes the sheet conveyed by said transport cylinder; and
a blowing device which blows air to the sheet conveyed by said transport cylinder on an upstream side in a sheet convey direction of a contact position where the sheet conveyed by said transport cylinder comes in contact with said processing cylinder.

2. A device according to claim 1, wherein said blowing device comprises an air blowing device including an air blow-off port with directivity,
said air blowing device blows air to the sheet which is under conveyance in a vicinity of the contact position with said processing cylinder.

3. A device according to claim 1, wherein said blowing device blows air to the upstream side in the sheet convey direction to regulate flutter of the sheet before the sheet passes through the contact position with said processing cylinder.

4. A device according to claim 1, wherein said blowing device includes
a plurality of first air blowing devices which blow air to the upstream side in the sheet convey direction, and
a second air blowing device which is arranged on a more upstream side in the sheet convey direction of said plurality of first air blowing devices, and directly blows air to a surface of the sheet.

5. A device according to claim 4, wherein
said first air blowing device includes an air blow-off port inclined at a predetermined angle with respect to an outer surface of said transport cylinder, and
said second air blowing device includes an air blow-off port inclined at an angle larger than the angle of the air blow-off port of said first air blowing device with respect to the outer surface of said transport cylinder.

6. A device according to claim 5, wherein
the air blow-off port of said first air blowing device obliquely blows air toward the upstream side in the sheet convey direction with respect to the outer surface of said transport cylinder, and
the air blow-off port of the second air blowing device blows air to a surface of a sheet conveyed by the counter cylinder.

7. A device according to claim 5, wherein each of said first air blowing device and said second air blowing device includes a plurality of nozzles each having the air blow-off port at a distal end.

8. A device according to claim 1, wherein said processing cylinder subjects the sheet conveyed by said transport cylinder to one of cut-marking, scoring, punching, and embossing.
